(19) United States
(12) Patent Application Publication
(10) Pub. No.: US 2007/0076078 A1
(43) Pub. Date: Apr. 5, 2007

(54) Method for forming a pattern and liquid ejection apparatus

(75) Inventors: Yuji Iwata, Suwa (JP); Hirotsuna Miura, Fujimi (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/541,950

(22) Filed: Oct. 2, 2006

(30) Foreign Application Priority Data
Oct. 4, 2005 (JP) 2005-291556

(51) Int. Cl. B41J 2/01

(52) U.S. Cl. 347/102

(57) ABSTRACT

A reflective mirror is provided between an ejection head and a substrate. A laser beam radiated by a laser head is multiply reflected between the reflective mirror and the ejection head and led to a radiating position on a surface of the substrate. This decreases the incident angle of the laser beam with respect to the reflective mirror, thus reducing the radiation angle of the laser beam at the radiating position.

### CROSS-REFERENCE TO RELATED APPLICATIONS

This application is based upon and claims the benefit of priority from prior Japanese Patent Application No. 2005-291556, filed on Oct. 4, 2005, the entire contents of which are incorporated herein by reference.

### BACKGROUND

1. Technical Field

The present invention relates to a method for forming a pattern and a liquid ejection apparatus.

2. Related Art

Typically, a display such as a liquid crystal display or an electroluminescence display includes a substrate that displays an image. The substrate has an identification code (for example, a two-dimensional code) representing encoded information including the site of production and the product number. The identification code is formed by structures (dots formed by colored thin films or recesses) that reproduce the identification code. The structures are provided in multiple dot formation areas (data cells) in accordance with a prescribed pattern.

As a method for forming the identification code, a laser sputtering method and a waterjet method have been described in JP-A-11-77340 and JP-A-2003-127537. In the laser sputtering method, films forming a code pattern are provided through sputtering. The waterjet method involves ejection of water containing abrasive material onto a substrate for marking a code pattern on the substrate.

However, to form the code pattern in a predetermined size by the laser sputtering method, the interval between a metal foil and a substrate must be adjusted to several or several tens of micrometers. The corresponding surfaces of the substrate and the metal foil thus must be extremely flat and the interval between the substrate and the metal foil must be adjusted with accuracy of the order of micrometer. Therefore, the laser sputtering method is applicable only to certain types of substrates, making it difficult to form identification codes in a wider range of substrates. In the waterjet method, water or dust or abrasive may splash onto and contaminate a substrate, when forming a code pattern on the substrate.

To solve these problems, an inkjet method has been focused on as an alternative method for forming an identification code. In the inkjet method, droplets of liquid containing metal particles is ejected from a nozzle. The droplets are then dried and thus form dots. The inkjet method is applicable to a wider variety of substrates and prevents contamination of the substrates caused by formation of the identification codes.

However, when drying droplets on a substrate, the inkjet method may have the following problem caused by the surface condition of the substrate or the surface tension of each droplet. Specifically, after having been received by the surface of the substrate, the droplet may spread wet on the substrate surface as the time elapses. Therefore, if the time necessary for drying the droplet exceeds a predetermined level (for example, 100 milliseconds), the droplet may spread beyond the corresponding data cell and reaches an adjacent data cell. This may lead to erroneous formation of the code pattern.

The problem may be avoided by radiating a laser beam onto a droplet of liquid on a substrate and quickly drying the droplet. However, as illustrated in FIG. 8, when a droplet Fb received by a surface of a substrate 102 is located immediately below a liquid ejection head 101, a laser beam B must be radiated onto the droplet Fb through a narrow gap between the liquid ejection head 101 and the substrate 102. The axis A of the laser beam B thus must be greatly inclined with respect to the normal line H of the substrate 102. In this case, as the inclination angle of the optical axis A increases, the beam spot of the laser beam B projected on the surface of the substrate enlarges. This lowers the radiation intensity of the laser beam B and decreases accuracy of the radiating position of the laser beam B.

### SUMMARY

Accordingly, it is an objective of the present invention to provide a method for forming a pattern and a liquid ejection apparatus that increases the radiation intensity and accuracy of the radiating position of a laser beam and enhances controllability of the formation of the pattern.

To achieve the foregoing objectives and in accordance with one aspect of the present invention, a method for forming a pattern by ejecting droplets of a liquid containing a pattern forming material from ejection ports defined in a liquid ejection head onto a substrate and radiating a laser beam from a laser source onto the droplets on the substrate is provided. The method includes: radiating the laser beam from the laser source onto a first reflecting member provided above the substrate, thereby reflecting the laser beam toward a second reflecting member arranged in the vicinity of the ejection ports by the first reflecting member; and reflecting the laser beam that has been reflected by the first reflecting member toward the droplet on the substrate by the second reflecting member.

In accordance with another aspect of the present invention, a liquid ejection apparatus including a liquid ejection head having an ejection port and a laser source radiating a laser beam is provided. A droplet of a liquid is ejected from the ejection port onto a substrate and a laser beam is radiated by the laser source onto the droplet on the substrate. The apparatus includes a first reflective member and a second reflecting member. The first reflecting member is provided above the substrate. The first reflecting member reflects the laser beam of the laser source toward the vicinity of the ejection port. The second reflecting member is arranged in the vicinity of the ejection port. The second reflecting member reflects the laser beam that has been reflected by the first reflecting member toward the droplet on the substrate.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a plan view showing a liquid crystal display having a pattern formed by a pattern forming method according to an embodiment of the present invention;

FIG. 2 is a perspective view showing a liquid ejection apparatus;

FIG. 3 is a perspective view showing a liquid ejection head and a laser head;

FIG. 4 is a cross-sectional view showing a liquid ejection head and a laser head according to a first embodiment of the present invention;

FIG. 5 is a block diagram representing the electric circuit of a liquid ejection apparatus according to the first embodiment;

FIG. 6 is a cross-sectional view showing a liquid ejection head and a laser head according to a second embodiment of the present invention;

FIG. 7 is a block diagram representing the electric circuit of a liquid ejection apparatus according to the second embodiment; and

FIG. 8 is a cross-sectional view schematically showing a typical liquid ejection apparatus.

### DESCRIPTION OF EXEMPLARY EMBODIMENTS

### First Embodiment

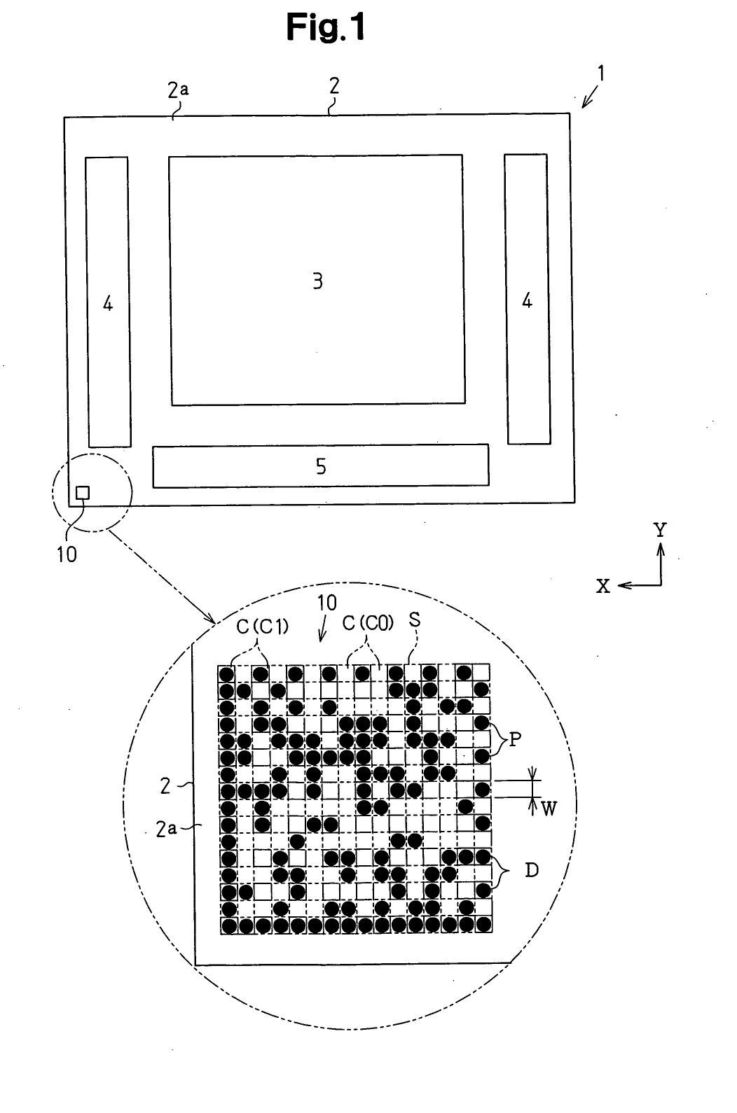

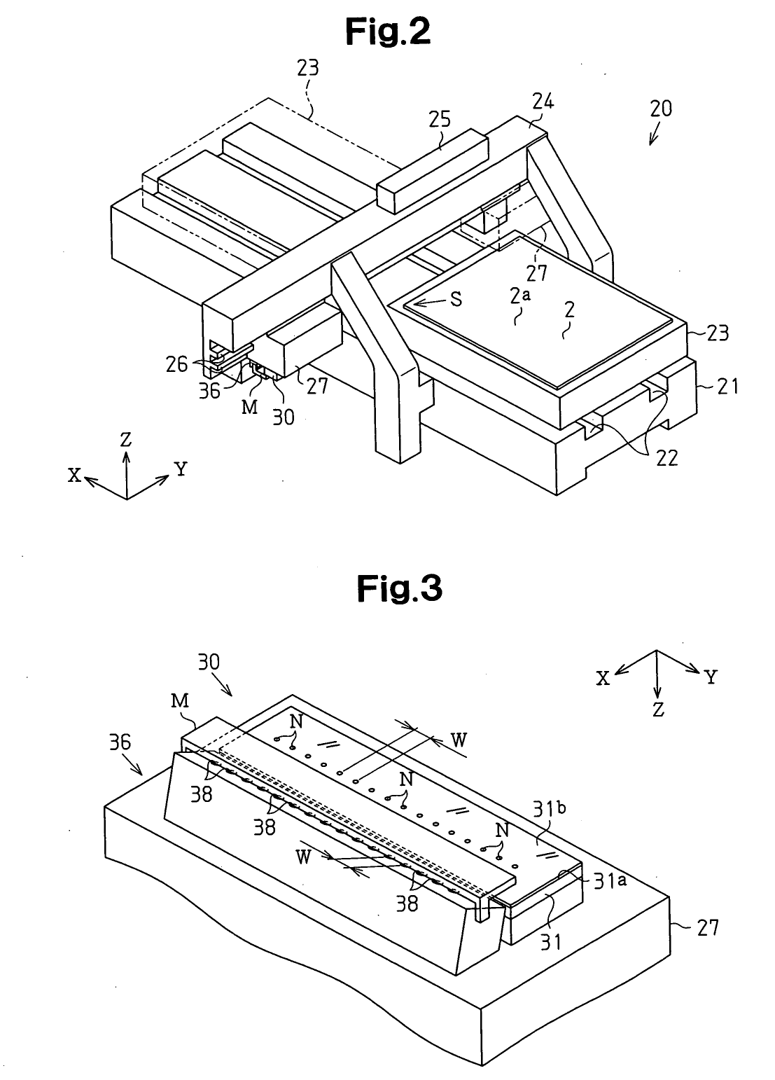

A first embodiment of the present embodiment will now be described with reference to FIGS. 1 to 5. In the description, direction X, direction Y, and direction Z are defined as illustrated in FIG. 2.

As shown in FIG. 1, a liquid crystal display 1 has a rectangular glass substrate (hereinafter, refereed to as a substrate) 2. A rectangular display portion 3 is formed substantially at the center of a surface 2a of the substrate 2. Liquid crystal molecules are sealed in the display portion 3. A scanning line driver circuit 4 and a data line driver circuit 5 are provided outside the display portion 3. In the liquid crystal display 1, the orientation of the liquid crystal molecules is adjusted in correspondence with a scanning signal generated by the scanning line driver circuit 4 and a data signal produced by the data line driver circuit 5. In accordance with the orientation of the liquid crystal molecules, area light radiated by an illumination device (not shown) is modulated to display an image on the display portion 3 of the substrate 2.

An identification code 10 indicating the product number or the lot number of the liquid crystal display 1 is formed at the left corner of the surface 2a of the substrate 2. The identification code 10 is formed by a plurality of dots D and provided in a code formation area S in accordance with a prescribed pattern. The code formation area S includes 256 data cells, aligned by 16 lines and 16 rows. Each of the data cells C is defined by virtually dividing the code formation area S, which has a square shape of 1 mm×1 mm, into equally sized sections. The dots D are formed in selected ones of the data cells C, thus forming the identification code 10. In the following, each of the cells C in which the dot D is provided is referred to as a black cell C1, or a dot forming position. Each of the empty cells C is referred to as a blank cell C0. The center of each black cell C1 is referred to as an “ejection target position P” and the length of each of the sides of the data cell C is referred to as “cell width W”.

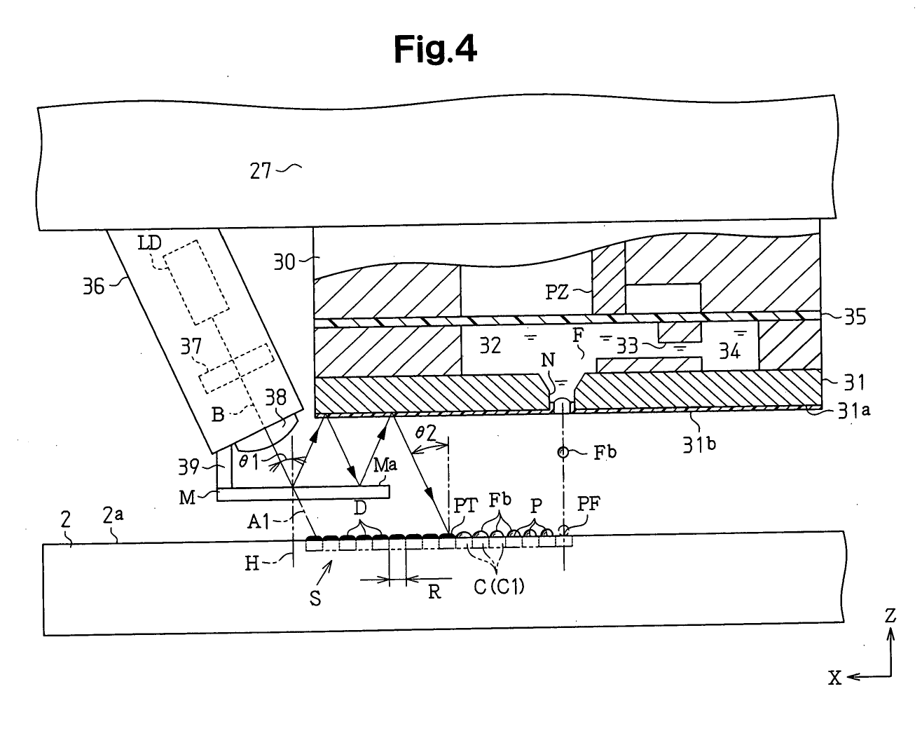

Each of the dots D is formed by ejecting a droplet Fb of liquid containing metal particles (for example, nickel or manganese particles) into the corresponding one of the data cells C (the black cells C1). The droplet Fb is then dried and baked in the cell C, thus providing the dot D (see FIG. 4). Alternatively, the dot D may be completed simply by drying the droplet Fb in the cell C through radiation of a laser beam.

A liquid ejection apparatus 20 for forming the identification code 10 will hereafter be explained.

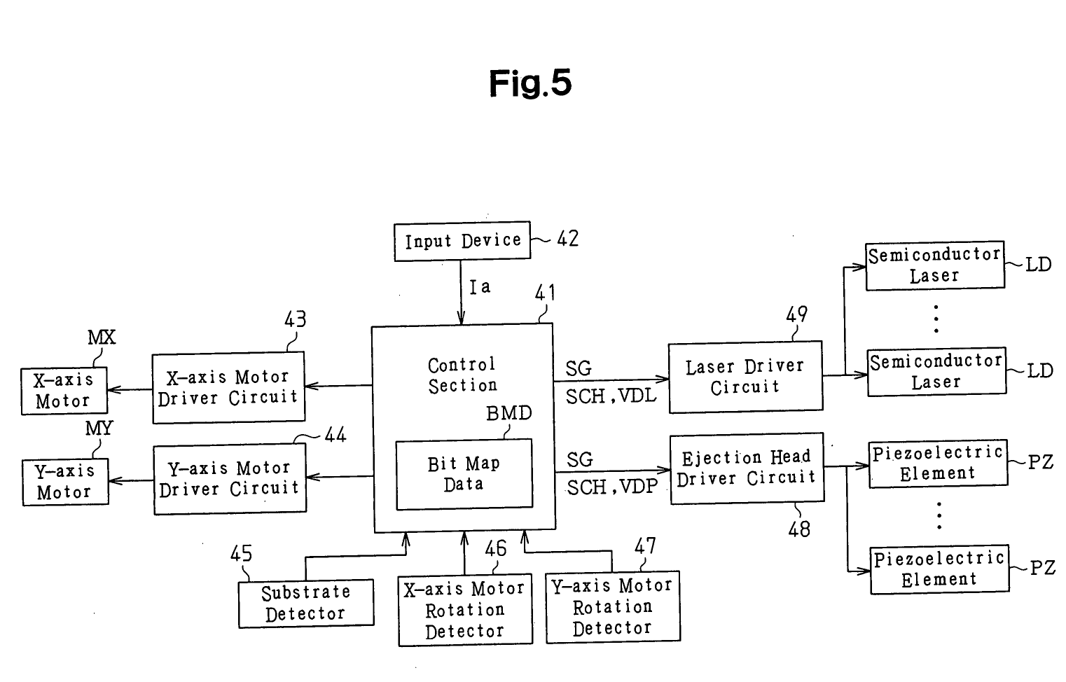

As shown in FIG. 2, the liquid ejection apparatus 20 has a parallelepiped base 21. A pair of guide grooves 22 are defined in the upper surface of the base 21 and extend in direction X. A substrate stage 23 is mounted on the base 21 and operably connected to an X-axis motor MX (see FIG. 5). When the X-axis motor MX runs, the substrate stage 23 moves in direction X or the direction opposite to direction X along the guide grooves 22. A suction type chuck mechanism (not shown) is provided on the upper surface of the substrate stage 23. The chuck mechanism operates to position and fix the substrate 2 on the substrate stage 23 at a predetermined position, with the surface 2a (the code formation area S) facing upward. In the following, the position of the substrate stage 23 rearmost in direction X (as indicated by the solid lines of FIG. 2) will be referred to as the first position. The position of the substrate stage 23 foremost in direction X (as indicated by the double-dotted broken lines of FIG. 2) will be referred to as the second position.

A gate-like guide member 24 is secured to opposing sides of the base 21. A reservoir tank 25 retaining liquid F (see FIG. 4) is mounted on the guide member 24. A pair of guide rails 26 extending along direction Y are provided in a lower portion of the guide member 24 and extend in direction Y. A carriage 27 is movably supported by the guide rails 26. The carriage 27 is operably connected to a Y-axis motor MY (see FIG. 5). The carriage 27 moves in direction Y or the direction opposite to direction Y along the guide rails 26. The carriage 27 reciprocates between a position indicated by the solid lines and a position indicated by the double-dotted broken lines in FIG. 2.

A liquid ejection head (hereinafter, referred to as an ejection head) 30 ejecting liquid droplets Fb (see FIG. 4) is secured to the lower surface of the carriage 27. FIG. 3 is a perspective view showing the ejection head 30 as viewed from the side corresponding to the substrate 2. As illustrated in FIG. 3, the ejection head 30 includes a nozzle plate 31, which serves as a second reflecting member, formed on the surface (the top surface as viewed in FIG. 3) of the ejection head 30 opposed to the substrate 2. The nozzle plate 31 is formed by a plate member formed of stainless steel. A surface (hereinafter, referred to as a second reflective surface) 31a of the nozzle plate 31 opposed to the substrate 2 is formed through mirror-surface machining to allow reflection of the laser beam B on the reflective surface 31a.

The second reflective surface 31a of the nozzle plate 31 is coated with a liquid repellent film 31b with a thickness of several hundreds of nanometers. The liquid repellent film 31b is a film transmissible to the laser beam B and formed of a silicone resin or a fluorine resin. The liquid repellent film 31b thus repels the liquid F. In the illustrated embodiment, the liquid repellent film 31b is formed directly on the second reflective surface 31a. However, a bonding layer of a thickness of several nanometers formed of a silane coupling agent or the like may be arranged between the second reflective surface 31a and the liquid repellent film 31b. The bonding layer improves bonding performance between the second reflective surface 31a and the liquid repellent film 31b.

A plurality of nozzles N, or ejection ports, are defined in the nozzle plate 31 and spaced at equal intervals along direction Y. The pitch of the nozzles N is set to a value equal to the cell width W of FIG. 1. As shown in FIG. 4, the second reflective surface 31a of the nozzle plate 31 is arranged parallel with the surface 2a of the substrate 2. Each of the nozzles N extends in a direction perpendicular to the surface 2a of the substrate 2 and through the nozzle plate 31. In the following, the position of the substrate 2 opposed to each of the nozzles N is referred to as a “droplet receiving position PF”.

Cavities 32 are defined in the ejection head 30. Each of the cavities 32 communicates with the reservoir tank 25 through a corresponding communication bore 33 and a common supply line 34. Therefore, the liquid F in the reservoir tank 25 is supplied to the nozzles N through the corresponding cavities 32. An oscillation plate 35, which oscillates in an upward-downward direction, is provided above each of the cavities 32 in the ejection head 30. Through oscillation of each oscillation plate 35, the volume of the corresponding cavity 32 is increased or decreased. A plurality of piezoelectric elements PZ are arranged on the oscillation plates 35 at positions corresponding to the nozzles N. When any one of the piezoelectric elements PZ repeatedly contracts and extends in an upward-downward direction, the corresponding one of the oscillation plates 35 oscillates in the upward-downward direction.

Specifically, the piezoelectric element PZ contracts and extends when the corresponding black cell C1 (ejection target position P) coincides with the receiving position PF through transportation of the substrate-stage 23 in direction X. This increases and decreases the volume of each cavity 32, ejecting the liquid F from the corresponding nozzle N as the droplet Fb by the amount corresponding to the decreased volume of the cavity 32. The droplet Fb then reaches the ejection target position P (the receiving position PF) on the substrate 2, which is arranged immediately below the corresponding nozzle N. After having reached the ejection target position P, the droplet Fb spreads wet as the time elapses and enlarges to the same size as the cell width W. In the following, the center of the droplet Fb (the ejection target position P) when the outer diameter of the droplet Fb becomes equal to the cell width W will be referred to as a “radiating position PT”.

A laser head 36 having a plurality of semiconductor lasers LD is provided in the vicinity of the ejection head 30. The semiconductor lasers LD serve as a laser radiation source. The laser beam B radiated by each of the semiconductor lasers LD has a wavelength range corresponding to the absorption range of the liquid F (including dispersion medium and metal particles). Each semiconductor laser LD has an optical system including a collimator 37 and a collective lens 38. The collimator 37 collimates the laser beam B of each semiconductor laser LD to a parallel flux of light. The collective lens 38 converges the laser beam B that has passed through the collimator 37 and guides the laser beam B to the surface 2a of the substrate 2. The optical axis A1 of the optical system is inclined with respect to the normal line H of the surface 2a of the substrate 2 at a predetermined angle θ1. The angle will hereafter be referred to as the “incident angle θ1”.

A reflective mirror M, or a first reflecting member, is secured to the laser head 36 through a securing part 39. The reflective mirror M is arranged between the ejection head 30 and the substrate 2 at a position forward from the radiating position PT in direction X. The surface of the reflective mirror M opposed to the ejection head 30 (a first reflective surface Ma) is provided parallel with a second reflective surface 31a of the nozzle plate 31. The first reflective mirror Ma of the reflective mirror M thus causes multiple reflection of the laser beam B with respect to the second reflective surface 31a of the nozzle plate 31.

The incident angle θ1 of the laser beam B is set in such a manner as to cause the multiple reflection of the laser beam B radiated by the laser head 36 between the reflective mirror M (the first reflective surface Ma) and the ejection head 30 (the second reflective surface 31a).

The incident angle θ1 is set to a minimum angle that permits guiding of the laser beam B to the radiating position PT, which is defined on the surface of the substrate 2, through the multiple reflection. This minimizes the radiation angle θ2 of the laser beam B at the radiating position PT.

In other words, the multiple reflection of the laser beam B between the reflective mirror M and the nozzle plate 31 decreases the radiation angle θ2 of the laser beam B at the radiating position PT. This suppresses enlargement of the beam spot of the laser beam B at the radiating position PT. The radiation intensity of the laser beam B with respect to the droplet Fb and accuracy of the radiating position of the laser beam B are thus improved. Although the beam spot of the illustrated embodiment has a substantially circular shape larger than each data cell C (the droplet Fb), the shape of the beam spot is not restricted to this shape.

When the droplet Fb reaches the radiating position PT, the corresponding semiconductor laser LD radiates the laser beam B. After having been multiply reflected between the reflective mirror M and the nozzle plate 31, the laser beam B is radiated onto the droplet Fb at the radiating position PT when the outer diameter of the droplet Fb becomes equal to the cell width W.

The laser beam B evaporates the dispersion medium from the droplet Fb, suppressing wet spreading of the droplet Fb. Meanwhile, the metal particles in the droplet Fb are baked through continuous radiation of the laser beam B. As a result, a semispherical dot D having an outer diameter equal to the cell width W is formed on the surface 2a of the substrate 2.

The electric circuit of the liquid ejection apparatus 20 will hereafter be explained with reference to FIG. 5.

As illustrated in FIG. 5, a control section 41 has a CPU, a RAM, and a ROM. The control section 41 performs procedures for moving the substrate stage 23 or operating the ejection head 30 or the laser head 36 in accordance with various data (regarding, for example, the movement speed of the substrate stage 23 or the cell width W) stored in the ROM and different control programs (such as an identification code formation program).

An input device 42 including a start switch and a stop switch is connected to the control section 41. The control section 41 receives operation signals and imaging data Ia representing an image of the identification code 10 from the input device 42. When receiving the imaging data Ia from the input device 42, the control section 41 performs a prescribed development process on the imaging data Ia. Further, to form the identification code 10, the control section 41 generates based on the imaging data Ia bit map data BMD indicating selected ones of the data cells C of the code formation area S onto which droplets Fb are to be ejected. The bit map data BMD is stored in the RAM. The bit map data BMD is 16×16 bit data corresponding to the data cells C. In accordance with the bit map data BMD, it is determined to whether to turn on or off the piezoelectric elements PZ (permit or prohibit ejection of the droplets Fb).

On the other hand, the control section 41 subjects the imaging data Ia to a development procedure different from the development procedure performed on the bit map data BMD. This generates the piezoelectric drive voltage VDP that drives each of the piezoelectric elements PZ and the laser drive voltage VDL that drives each of the semiconductor lasers LD.

An X-axis motor driver circuit 43 and a Y-axis motor driver circuit 44 are connected to the control section 41. The control section 41 sends a control signal to the X-axis motor driver circuit 43 for actuating the X-axis motor MX. The control section 41 sends a control signal to the Y-axis motor driver circuit 44 for actuating the Y-axis motor MY. In response to the control signal of the control section 41, the X-axis motor driver circuit 43 operates to rotate the X-axis motor MX in a forward or reverse direction, thus reciprocating the substrate stage 23. In response to the control signal of the control section 41, the Y-axis motor driver circuit 44 operates to rotate the Y-axis motor MY in a forward or reverse direction, thus reciprocating the carriage 27.

A substrate detector 45 having an imaging function is connected to the control section 41. The substrate detector 45 is capable of detecting an end of the substrate 2. In correspondence with a detection signal sent from the substrate detector 45, the control section 41 calculates the position of the substrate 2.

An X-axis motor rotation detector 46 and a Y-axis motor rotation detector 47 are connected to the control section 41. The X-axis motor rotation detector 46 and the Y-axis motor rotation detector 47 send detection signals to the control section 41.

The control section 41 detects the rotational direction and rotation amount of the X-axis motor MX in accordance with a detection signal sent from the X-axis motor rotation detector 46. The movement direction in direction X and the movement amount of the substrate 2 relative to the ejection head 30 are thus calculated. When the center of one of the data cells C coincides with the receiving position PF, the control section 41 provides an ejection timing signal SG to the ejection head driver circuit 48 and the laser driver circuit 49.

The control section 41 detects the rotational direction and rotation amount of the Y-axis motor MY in accordance with a detection signal sent from the Y-axis motor rotation detector 47. The movement direction and the movement amount of the substrate 2 relative to the ejection head 30 are thus calculated. Then, the control section 41 causes the carriage 27 to reciprocate such that the receiving position PF corresponding to the associated nozzle N is located on the movement path of the ejection target position P.

The ejection head driver circuit 48 is connected to the control section 41. The control section 41 generates a head control signal SCH by synchronizing the bit map data BMD corresponding to a single scanning cycle of the substrate 2 with a prescribed clock signal. The head control signal SCH is serially transferred to the ejection head driver circuit 48. Further, the control section 41 sends the piezoelectric element drive voltage VD to the head driver circuit 48 synchronously with a prescribed clock signal. The ejection head driver circuit 48 performs serial-parallel conversion on the head control signal SCH serially transferred from the control section 41 in correspondence with the piezoelectric elements PZ. In response to the ejection timing signal SG of the control section 41, the ejection head driver circuit 48 supplies the piezoelectric element drive voltage VDP to the piezoelectric element PZ corresponding to the head control signal SCH. As a result, the droplet Fb is ejected from the nozzle N corresponding to the head control signal SCH (the bit map data BMD).

The laser driver circuit 49 is connected to the control section 41. The control section 41 serially transfers the head control signal SCH to the laser driver circuit 49 and supplies the laser drive voltage VDL to the laser driver circuit 49 synchronously with a prescribed clock signal. The laser driver circuit 49 converts the head control signal SCH, which has been serially transferred from the control section 41, into parallel signals in correspondence with the semiconductor lasers LD. The laser driver circuit 49 stands by for a predetermined time after having received the ejection timing signal SG from the control section 41. The laser driver circuit 49 then supplies the laser drive voltage VDL to the semiconductor laser LD corresponding to the head control signal SCH. As a result, the laser beam B is radiated from the semiconductor laser LD corresponding to the nozzle N from which the droplet Fb has been ejected.

In the following, the time from when the laser driver circuit 49 receives the ejection timing signal SG to when the semiconductor laser LD is supplied to the laser drive voltage VDL will be referred to as the “standby time”. The standby time corresponds to the time from when the droplet Fb reaches the substrate 2 to when the droplet Fb reaches the radiating position PT. When the outer diameter of each droplet Fb becomes equal to the cell width W after the standby time has elapsed since ejection of the droplet Fb from the corresponding nozzle N, the semiconductor laser LD corresponding to the nozzle N from which the droplet Fb has been ejected radiates the laser beam B.

A method for forming the identification code 10 using the liquid ejection apparatus 20 will hereafter be explained with reference to FIGS. 2 to 5.

First, the substrate 2 is fixed to the substrate stage 23 with the surface 2a facing upward. In this state, the substrate 2 is located rearward from the guide member 24 in direction X.

Subsequently, the imaging data Ia is input to the control section 41 through manipulation of the input device 42. The control section 41 then produces the bit map data BMD based on the imaging data Ia. Further, the control section 41 generates the piezoelectric element drive voltage VDP and the laser drive voltage VDL, which drive the piezoelectric elements PZ and the semiconductor lasers LD, respectively.

The control section 41 then actuates the Y-axis motor MY to transport the carriage 27 (the nozzles N) from the position shown by the solid lines in FIG. 2 in direction Y in such a manner that each of the ejection target positions P passes the corresponding one of the receiving positions PF. Once the carriage 27 is set at a predetermined position, the control section 41 actuates the X-axis motor MX to move the substrate stage 23 in direction X, thus starting transporting the substrate 2.

The control section 41 determines whether the black cells C1 (the ejection target positions P) have reached the corresponding receiving positions PF in correspondence with detection signals sent from the substrate detector 45 and the X-axis motor rotation detector 46.

When the black cells C1 move to the receiving positions PF, the control section 41 outputs the piezoelectric element drive voltage VDP and the head control signal SCH to the ejection head driver circuit 48. The control section 41 also supplies the laser drive voltage VDL and the head control signal SCH to the laser driver circuit 49. The control section 41 then stands by until the control section 41 must output the ejection timing signals SG to both of the ejection head driver circuit 48 and the laser driver circuit 49.

When the black cells C1 (the ejection target positions P) of the first row reach the corresponding receiving positions PF, the control section 41 sends the ejection timing signals SG to the ejection head driver circuit 48 and the laser driver circuit 49.

After having sent the ejection timing signals SG, the control section 41 supplies the piezoelectric element drive voltage VDP to the piezoelectric elements PZ corresponding to the head control signal SCH. This causes the nozzles N corresponding to the head control signal SCH to eject the droplets Fb simultaneously. The outer diameter of the droplet Fb increases to the size equal to the cell width W by the time the droplet Fb reaches the receiving position PF (the ejection target position P) on the surface of the substrate 2.

After the standby time has elapsed since output of the ejection timing signal SG, the control section 41 supplies the laser drive voltage VDL to the semiconductor lasers LD corresponding to the head control signal SCH. The semiconductor lasers LD thus simultaneously radiate the laser beams B. The laser beams B are then multiply reflected between the reflective mirror M and the nozzle plate 31 and radiated onto the corresponding droplets Fb at the radiating positions PT when the outer diameter of the droplets Fb become equal to the cell width W. The laser beams B thus evaporate dispersion medium from the droplets Fb and bake the metal particles of the droplets Fb. As a result, the dots D each having an outer diameter equal to the cell width W are formed on the surface 2a of the substrate 2. That is, the dots D with the outer diameter equal to the cell width W are provided in the black cells C1 of the first row.

Afterwards, each time the target ejection positions P reach the corresponding receiving positions PF, the droplets Fb are simultaneously ejected from the corresponding nozzles N in the above-described manner. When the outer diameter of each droplet Fb is equal to the cell width W, the laser head 36 is caused to simultaneously radiate the laser beams B onto the droplets Fb. In this manner, the dots D are formed in the code formation area S in accordance with a prescribed pattern, thus providing the identification code 10.

The first embodiment has the following advantages.

(1) The reflective mirror M is provided between the ejection head 30 and the substrate 2. The laser beam B radiated by the laser head 36 is multiply reflected between the first reflective surface Ma of the reflective mirror M and the second reflective surface 31a of the ejection head 30. The laser beam B is then sent to the radiating position PT. This reduces the incident angle θ1 of the laser beam B with respect to the reflective mirror M, decreasing the incident angle θ2 of the laser beam B at the radiating position PT.

Through such multiple reflection of the laser beam B between the reflective mirror M and the nozzle plate 31, the laser beam B can be radiated onto the droplet Fb at the radiating position PT in a substantial normal direction of the surface 2a of the substrate 2. This suppresses enlargement of the beam spot of the laser beam B at the radiating position PT. The radiation intensity of the laser beam B radiated onto the droplet Fb is thus enhanced and the accuracy of the radiating position of the laser beam B with respect to the droplet Fb is improved. The controllability for shaping the dots D is also increased.

(2) The nozzle plate 31 (the second reflective surface 31a) is employed as the second reflecting member. This decreases the number of the components of the liquid ejection apparatus 20 compared to a case in which a separate reflecting member is employed. That is, the radiation intensity and the accuracy of the radiation position of the laser beam B are improved by the liquid ejection apparatus 20 that is simply configured.

(3) The second reflective surface 31a of the nozzle plate 31 is coated with a liquid repellent film 31b, which repels the liquid F and is transmissible to the laser beam B. This prevents the second reflective surface 31a of the nozzle plate 31 from being contaminated easily. This maintains the optical performance of the second reflective surface 31a, stabilizing the radiation intensity of the laser beam B with respect to the droplet Fb and the accuracy of the radiating position of the laser beam B.

### Second Embodiment

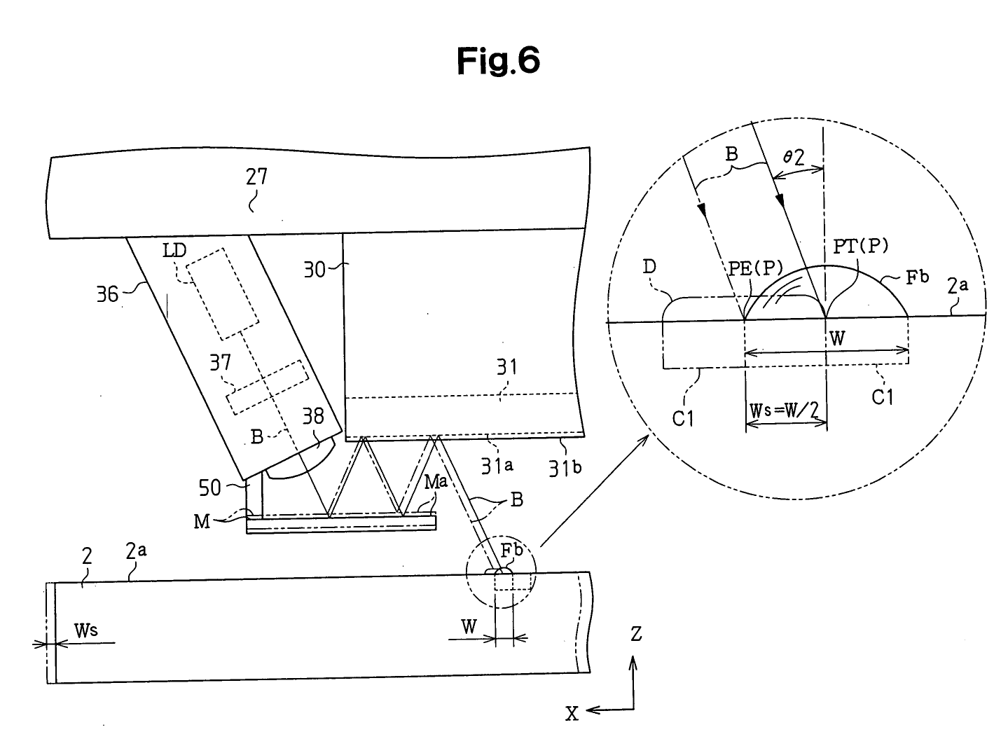

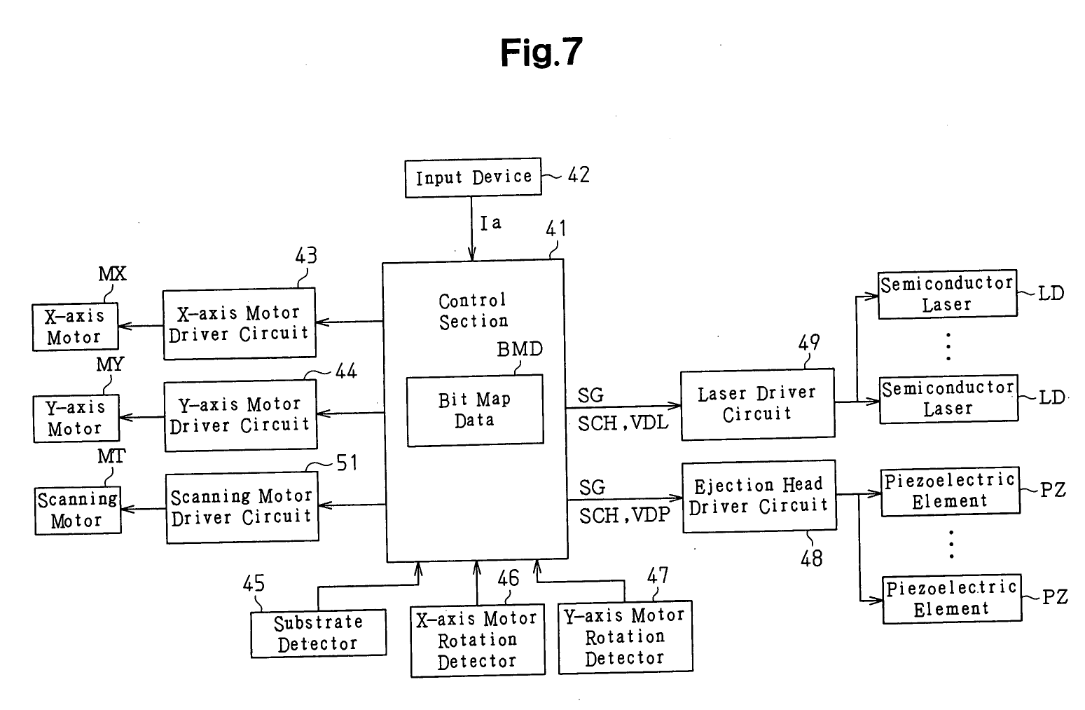

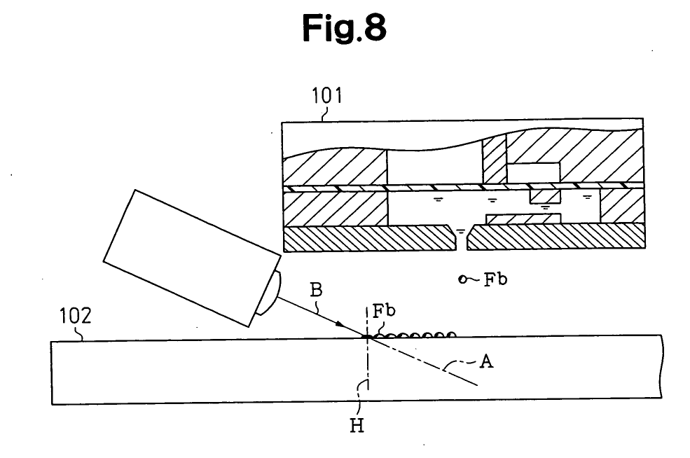

A second embodiment of the present invention will now be described with reference to FIGS. 6 and 7. Same or like reference numerals are given to parts of the second embodiment that are the same as or like corresponding parts of the first embodiment. Detailed description of these parts will be omitted. In the second embodiment, the reflective mirror M is movable unlike the first embodiment. Although a single data cell C and a single droplet Fb on the data cell C are illustrated in FIG. 6, multiple data cells C and multiple droplets Fb may be provided on the substrate 2, as in the first embodiment.

As shown in FIGS. 6 and 7, a lift mechanism 50 is secured to the distal end of the laser head 36 for selectively raising and lowering the reflective mirror M. The lift mechanism 50 is driven by a scanning motor MT.

When the reflective mirror M is located at the lowermost position indicated by the solid lines of FIG. 6, the laser beam B that has been reflected between the reflective mirror M and the nozzle plate 31 is led to the radiating position PT. Contrastingly, when the reflective mirror M is located at the uppermost position indicated by the double-dotted broken lines of FIG. 6, the laser beam B that has been reflected between the reflective mirror M and the nozzle plate 31 is sent to a position (a radiation end position PE) offset from the radiating position PT in direction X by the amount corresponding to a half of the cell width W. In other words, while the reflective mirror M is moving (rising) from the lowermost position to the uppermost position, the laser beam B is scanned from the radiating position PT to the radiation end position PE. In the following, the distance between the radiating position PT and the radiation end position PE will be referred to as the scanning distance Ws.

As the substrate 2 (the substrate stage 23) moves in direction X by the scanning distance Ws, the reflective mirror M moves from the lowermost position to the uppermost position. The reflective mirror M reaches the lowermost position when each of the ejection target positions P (the center of each droplet Fb) passes the corresponding one of the radiating positions PT. The reflective mirror M is then lifted to the uppermost position when each ejection target position P (the center of each droplet Fb) passes the radiation end position PE.

A scanning motor driver circuit 51 is connected to the control section 41 serving as a scanning control device. The control section 41 outputs an ejection timing signal SG to the scanning motor driver circuit 51. After the standby time has elapsed since reception of the ejection timing signal SG, the scanning motor driver circuit 51 sends a signal (a scanning motor control signal) to the scanning motor MT for lifting and lowering the reflective mirror M located at the lowermost position for a single cycle. That is, the control section 41 starts moving the reflective mirror M in correspondence with the timing at which the semiconductor laser LD radiates the laser beam B. The control section 41 synchronizes the scanning cycle of the laser beam B with the movement cycle of the ejection target position P (the droplet Fb) to the radiating position PT. As a result, while the laser beam B is being scanned in accordance with the scanning distance Ws, the laser beam B is continuously radiated onto the center of the droplet Fb (the ejection target position P).

A laser driver circuit 49 is connected to the control section 41. The laser driver circuit 49 converts the head control signal SCH that has been serially transferred from the control section 41 to parallel signals in correspondence with the semiconductor lasers LD. After the standby time has elapsed since reception of the ejection timing signal SG from the control section 41, the laser driver circuit 49 supplies the laser drive voltage VDL to the semiconductor lasers LD corresponding to the head control signal SCH. In the following, the time for which the laser drive voltage VDL is continuously supplied will be referred to as the “radiation time”. The radiation time corresponds to the time necessary for transportation of the droplet Fb to cover the scanning distance Ws, or the time necessary for accomplishing the single raising and lowering cycle of the reflective mirror M.

With the reflective mirror M located at the lowermost position, the control section 41 outputs the ejection timing signal SG to the ejection head driver circuit 48, the laser driver circuit 49, and the scanning motor driver circuit 51 in correspondence with the timing at which the black cells C1 (the ejection target positions P) of the first row pass the receiving positions PF.

After the standby time has elapsed since output of the ejection timing signal SG, the droplet Fb reaches the radiating position PT from the receiving position PF. The control section 41 then outputs a control signal that instructs radiation of the laser beam B and lifting of the reflective mirror M to the laser driver circuit 49 and the scanning motor driver circuit 51 in correspondence with the timing at which the droplet Fb passes the radiating position PT. As a result, radiation of the laser beam B by the corresponding semiconductor laser LD and lifting of the reflective mirror M are started.

The laser beam B is then multiply reflected between the reflective mirror M and the nozzle plate 31 and radiated onto the droplet Fb at the radiating position PT at the radiation angle θ2. Subsequently, while the substrate 2 is transported in direction X, the reflective mirror M is continuously raised. Scanning of the laser beam B is thus continued in such a manner that the laser beam B is continuously radiated onto the center of the droplet Fb at the radiation angle θ2.

After the “radiation time” has elapsed since radiation of the laser beam B, the control section 41 sends a control signal that instructs suspension of the radiation of the laser beam B and lowering of the reflective mirror M to the laser driver circuit 49 and the scanning motor driver circuit 51 in correspondence with the timing at which the droplet Fb passes the radiation end position PE.

Afterwards, every time the droplet Fb (the ejection target position P) reaches the radiating position PT, the control section 41 operates to raise the reflective mirror M and scan the laser beam B. During scanning of the laser beam B in accordance with the scanning distance Ws (during the scanning time), the laser beam B is continuously radiated onto the center of the droplet Fb. This increases the amount of the laser beam B radiated onto the droplet Fb. Insufficient drying or baking of the droplet Fb is thus suppressed so that the obtained dot D is sized in accordance with the cell width W.

The second embodiment has the following advantages.

(1) The reflective mirror M is secured to the distal end of the laser head 36. By selectively raising and lowering the reflective mirror M, the laser beam B radiated onto the surface 2a of the substrate 2 is scanned in direction X. Further, by synchronizing the scanning cycle of the laser beam B with the movement cycle of the ejection target position P (the droplet Fb) with respect to the radiating position PT, the center of the droplet Fb (the ejection target position P) is continuously irradiated with the laser beam B.

Through such scanning of the laser beam B in accordance with the scanning distance Ws, the time for which the droplet Fb is irradiated with the laser beam B is prolonged. This suppresses insufficient drying or baking of the droplet Fb, improving controllability for shaping the dot D.

The illustrated embodiments may be modified in the following forms.

In the illustrated embodiments, the laser beam B is reflected by the reflective mirror M and the nozzle plate 31 for multiple times. However, the laser beam B may be reflected by each of the reflective mirror M and the nozzle plate 31 for a single time separately.

In the illustrated embodiment, the first reflective surface Ma of the reflective mirror M and the second reflective surface 31a of the nozzle plate 31 may be curved in such a manner as to guide the laser beam B reflected between the reflective mirror M and the nozzle plate 31 to the radiating position PT.

A member different from (separate from) the nozzle plate 31 may be attached to the lower surface of the ejection head 30. In this case, the attached member functions as a second reflecting member.

In the illustrated embodiments, the liquid repellent film 31b may be formed on the first reflective surface Ma of the reflective mirror M or each of the first reflective surface Ma and the second reflective surface 31a. In the latter case, the first reflective surface Ma and the second reflective surface 31a are both prevented from being contaminated by the droplets Fb.

In the second embodiment, scanning of the laser beam B is performed by selectively raising and lowering the reflective mirror M. However, a second reflecting member may be secured to the nozzle plate 31. In this case, the laser beam B is scanned by selectively raising and lowering the second reflecting member or both of the reflective mirror M and the second reflecting member.

In the second embodiment, the intensity or the wavelength range of the laser beam B may be modified in correspondence with the scanning cycle of the laser beam B. For example, the intensity of the laser beam B may be lowered when the laser beam B is radiated onto the radiating position PT and enhanced toward the radiation end position PE. Therefore, bumping of the droplet Fb is suppressed by the lowered intensity of the laser beam B while baking of the metal particles of the droplet Fb is reliably accomplished by the increased intensity of the laser beam B.

Although the substrate stage 23 transporting the substrate 2 is embodied as a relative movement device, the carriage 27 may be embodied as the relative movement device.

In the illustrated embodiment, the droplets Fb may be caused to flow in a desired direction using energy generated by the laser beams B. Alternatively, by radiating the laser beam only to the outer peripheral end of each droplet Fb, the surface of the droplet Fb may be solidified (pinned) exclusively. In other words, the present invention may be applied to any other suitable method by which dots are formed through radiation of the laser beams B onto the droplets Fb.

In the illustrated embodiment, a carbon dioxide gas laser or a YAG laser may be used as a laser radiation source. That is, any suitable laser radiation source may be employed as long as the wavelength of the radiated laser beam B causes drying of the droplet Fb.

The present invention may be applied to a method for forming a pattern of an insulating film or metal wiring of a field effect type device (FED or SED). The field effect type device emits light from a fluorescent substance using electrons released from a flat electron release element. In other words, the present invention may be applied to any other suitable method for forming patterns by radiating laser beams B onto droplets Fb.

In the illustrated embodiment, the substrate 2 may be, for example, a silicone substrate, a flexible substrate, or a metal substrate.

1. A method for forming a pattern by ejecting droplets of a liquid containing a pattern forming material from ejection ports defined in a liquid ejection head onto a substrate and radiating a laser beam from a laser source onto the droplets on the substrate, the method comprising:
radiating the laser beam from the laser source onto a first reflecting member provided above the substrate, thereby reflecting the laser beam toward a second reflecting member arranged in the vicinity of the ejection ports by the first reflecting member; and
reflecting the laser beam that has been reflected by the first reflecting member toward the droplet on the substrate by the second reflecting member.

2. The method according to claim 1, further comprising changing the path of the laser beam radiated by the laser source in correspondence with movement of each droplet relative to the laser source and scanning the droplet with the laser beam.

3. A liquid ejection apparatus including a liquid ejection head having an ejection port and a laser source radiating a laser beam, where a droplet of a liquid is ejected from the ejection port onto a substrate and a laser beam is radiated by the laser source onto the droplet on the substrate, the apparatus comprising:
a first reflecting member provided above the substrate, the first reflecting member reflecting the laser beam of the laser source toward the vicinity of the ejection port; and
a second reflecting member arranged in the vicinity of the ejection port, the second reflecting member reflecting the laser beam that has been reflected by the first reflecting member toward the droplet on the substrate.

4. The apparatus according to claim 3, wherein the first reflecting member is arranged between the liquid ejection head and the substrate.

5. The apparatus according to claim 3, wherein the first reflecting member is arranged forward in a movement direction of the substrate from a radiating position at which a surface of the substrate is irradiated with the laser beam.

6. The apparatus according to claim 3, wherein the second reflecting member is formed by a nozzle plate having the ejection port.

7. The apparatus according to claim 3, wherein a surface of at least one of the first reflecting member and the second reflecting member is covered with a liquid repellent film that is transmissible to the laser beam and repels the droplet.

8. The apparatus according to claim 3, wherein at least one of the first reflecting member and the second reflecting member changes the path of the laser beam radiated by the laser source and scans the droplet on the substrate with the laser beam.

9. The apparatus according to claim 3, further comprising:
a relative movement device that moves the substrate relative to the laser source; and
a scanning control device that controls operation of at least one of the first reflecting member and the second reflecting member in such a manner that the laser beam of the laser source is scanned in correspondence with movement of the droplet relative to the laser source.
